(19) United States
(12) Patent Application Publication
(10) Pub. No.: US 2006/0013305 A1
(43) Pub. Date: Jan. 19, 2006

(54) Temporal scalable coding using AVC coding tools

(75) Inventor: Shijun Sun, Vancouver, WA (US)

Correspondence Address: SHARP LABORATORIES OF AMERICA, INC, 5750 NW PACIFIC RIM BLVD, CAMAS, WA, 98642, US

(73) Assignee: Sharp Laboratories of America, Inc.

(21) Appl. No.: 10/951,863

(22) Filed: Sep. 27, 2004

Related U.S. Application Data
(60) Provisional application No. 60/587,922, filed on Jul. 14, 2004.

(51) Int. Cl. H04B 1/66; H04N 7/12; H04N 11/04; H04N 11/02

(52) U.S. Cl. 375/240.12

(57) ABSTRACT

A temporally scalable video coding method is provided to interleave pictures from all layers of a video sequence including video sub-sequences organized using enhancement layers following a set of rules: (1) pictures in each layer are to be coded sequentially within the layer; (2) a picture from an upper layer should be coded when its temporally closest neighboring pictures among all lower layers (in both forward and backward directions if available) have been already coded; in other words, coding of an upper-layer picture requires the temporally closest neighboring pictures among all lower layers (in both forward and backward directions if available) be coded before hand. To ensure a reasonable coding efficiency, for each picture, its qualified reference pictures may be reordered so that the reference pictures are ordered using their relative temporal distance from the current picture instead of the default picture coding order.

### CROSS-REFERENCE TO RELATED CASES

The present application claims the benefit of U.S. Provisional Application No. 60/587,922, filed Jul. 14, 2004, invented by Shijun Sun, and entitled “Temporal Scalable Coding Using AVC Coding Tools,” which is hereby incorporated herein by reference.

### BACKGROUND OF THE INVENTION

The present method relates to video encoding, and more particularly to video coding using sub-sequences to achieve temporal scalability.

There have been discussions in recent MPEG meetings for Scalable Video Coding (SVC). The coding method proposed in the meetings can be categorized into two groups: wavelet-based coding, and Advanced Video Coding (AVC) based coding. AVC refers herein generally to various advanced video coding standards efforts, which may include H.26L, ITU-T H.264, MPEG-4 (Part 10), commonly referred to as H.264/AVC. The AVC-based methods so far have given better performance than the other group. An AVC-based coding method typically provides a base layer, and adds various enhancement scalable information on top of it to enable spatial, temporal, and quality scalability.

The temporal scalability in most current practices use the Motion Compensated Temporal Filter (MCTF), which is much more complex than the traditional motion compensation method in the AVC standard. However, many people have overlooked the other possible temporal scalable coding options supported by AVC coding tools.

It is straightforward to divide the sequences into Group of Pictures (or GOP's), and code the pictures within a GOP layer-by-layer, starting from lowest layer. However, since the Decoded Picture Buffer (DPB) is limited by the AVC standard, if we code an AVC (a.k.a. H.264) bitstream following the same picture ordering strategy, the GOP size will be limited by the number of pictures allowed in the DPB (i.e., 15 pictures at most in some current proposals) and the coding efficiency will therefore suffer.

### SUMMARY

Accordingly, this disclosure is to set up a general rule for picture order in temporal scalable coding using AVC sub sequences. The general rule may enable an efficient temporal scalable coding in a compliant AVC bitstream.

The method introduced here is to interleave the pictures from all layers following a set of rules: (1) pictures in each layer are to be coded sequentially within the layer; (2) a picture from an upper layer should be coded when its temporally closest neighboring pictures among all lower layers (in both forward and backward directions if available) have been already coded; in other words, coding of an upper-layer picture requires the temporally closest neighboring pictures among all lower layers (in both forward and backward directions if available) be coded before hand. Using this method, the GOP size may not be strictly limited, so GOP size can be very flexible and coding efficiency may therefore be improved relative to a brute-force scalable coding. To ensure a reasonable coding efficiency, for each picture, its qualified reference pictures are reordered so that the reference pictures are ordered using their relative temporal distance from the current picture instead of the default picture coding order.

### BRIEF DESCRIPTION OF THE DRAWINGS

FIG. 1 contains a Picture Coding Order Table 1.

FIG. 2 contains a Picture Coding Order Table 2.

FIG. 3 contains a Picture Coding Order Table 3.

FIG. 4 contains a Picture Coding Order Table 4.

FIG. 5 contains a Picture Coding Order Table 5.

FIG. 6 contains a Picture Coding Order Table 6.

FIGS. 7 through 16 illustrate comparisons of test results.

FIG. 17 is a flow chart.

### DETAILED DESCRIPTION OF THE INVENTION

For Baseline/Extended profile applications, where temporal scalability might be very beneficial, supplemental enhancement information (SEI) messages may be utilized. Additionally, for Main and FRExt profile applications, we can use the B pictures and the Stored-B pictures (Bs in short). B pictures naturally enable scalability but its coding efficiency might not be as good as that of Bs. For both Baseline and Main profile applications, the reference-reordering tool in AVC is useful for retaining reasonable coding quality.

The AVC standard allows a sequence to be coded in layers indicated by the sub-sequence messages. A picture coded in a higher layer can use other pictures in the same and lower layers as references. Meanwhile, a picture in a lower layer cannot use picture from a higher layer as reference. The coding tool naturally enables a temporal scalable coding. However, there has not been any open discussion on how to use it for an optimal coding efficiency.

As used herein the base layer, also referred to as layer-0, is considered the lowest layer and corresponds to the lowest picture-rate for temporal scalability purposes. The term upper layer, or upper, refers to a layer that corresponds to a higher total picture-rate, when combined with all lower layers, than is achieved by the combination of just the lower layers. The upper layers correspond to enhancement layers and maybe identified as layer-1, layer-2, etc for convenience.

An embodiment of the present method interleaves the pictures from all layers following a set of rules: (1) pictures in each layer are to be coded sequentially within the layer; (2) a picture from an upper layer should be coded when its temporally closest neighboring pictures among all lower layers (in both forward and backward directions if available) have been already coded; in other words, coding of an upper-layer picture requires the temporally closest neighboring pictures among all lower layers (in both forward and backward directions if available) be coded before hand. The advantages of such picture coding order arrangement is that the GOP size is not strictly limited, so GOP size can be very flexible and coding efficiency may therefore be improved relative to a brute-force scalable coding. To ensure a reasonable coding efficiency, for each picture, its qualified reference pictures are reordered so that the reference pictures are ordered using their relative temporal distance from the current picture instead of the default picture coding order.

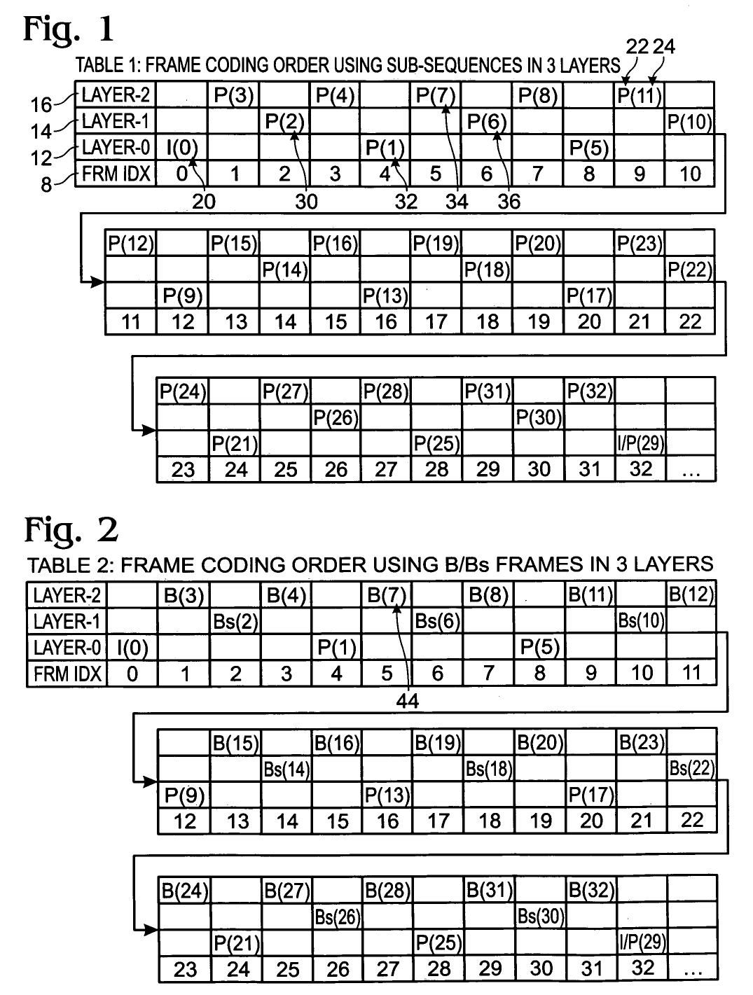

Table 1 in FIG. 1 gives one example for a 33-picture clip arranged in 3 sub-sequence layers. The three sub-sequence layers are the base layer 12, which is referred to as layer-0, and a first enhancement layer 14, which is referred to as layer-1, and a second enhancement layer 16, which is referred to as layer-2. The picture coding order 8, which is referred to as Form Idx, is given to each picture in the sequence shown here by way of example from 0 to 32. The minimum DPB size required by this arrangement is only 6 pictures, which is much smaller than the maximum AVC allowance proposed (i.e. 15 pictures). The sequence shown is made up of intra (I) pictures 20 and predicted (P) pictures 22. The value 24 in parenthesis following each I or P designation for a picture refers to that pictures coding order. In an embodiment of the present method, as indicated at Form Idx position 32, pictures in the base layer 12 may be either I pictures or P pictures.

To implement the temporal scalability of the present method, a picture from an upper layer should be coded when its temporally closest neighboring pictures among all lower layers (in both forward and backward directions if available) have been already coded; in other words, coding of an upper-layer picture requires the temporally closest neighboring pictures among all lower layers (in both forward and backward directions if available) be coded before hand. Taking for example picture P(2) 30 it will be coded after its temporally closest neighboring pictures among all lower layers, in this case the base layer 12, have been coded. In this case, the temporally closest preceding picture on base layer 12 is picture I(0) 20, and the temporally closest successive picture on base layer 12 is picture P(1) 32. As indicated by the coding order, P(2) should be coded after I(0) and P(1) have already been coded, even though P(2) is located temporally prior to P(1).

Taking for example picture P(7) 34, it will be coded after its temporally closest neighboring pictures among all lower layers, in this case the base layer 12, and first enhancement layer 14, have been coded. In this case, the temporally closest preceding picture is on base layer 12 at picture P(1) 32, and the temporally closest successive picture is on first enhancement layer 14 at P(6) 36. As indicated by the coding order, P(7) should be coded after P(1) and P(6) have already been coded, even though P(7) is located temporally prior to P(6). Although P(2) 30 is the temporally closest neighboring picture to P(7) on the first enhancement layer 14, it is not the temporally closest preceding neighboring picture among all lower layers. P(1) on the base layer 12 is the temporally closest preceding neighboring picture among all lower layers.

The reference pictures are ordered according to their coding order by default. For example the default reference order for P(7) 34 would correspond to:
I(0), P(1), P(2), P(3), P(4), P(5), P(6), (P(7)) list 0
   In an embodiment of the present method, coding efficiency is improved by reordering the reference pictures using their relative temporal distance instead of their default coding order. The resulting reference order is arranged so that the temporally closest pictures are moved to their corresponding temporal distance, for example:
I(0), P(3), P(5), P(2), P(4), P(6), P(1), (P(7)) list 0
   In an embodiment of the present method, where two pictures have the same relative temporal distance the preceding reference picture is given preference over a subsequent reference picture. The reordering of picture references may be accomplished by providing a reference reorder command for each reference picture to be pulled forward.

In another embodiment of the present method, the reference pictures are only partially reordered. One or more of the temporally closest pictures are reordered, while those more remote reference pictures are not reordered. For example, in the following case only the reference picture within a temporal distance of one is reordered, as shown:
I(0), P(2), P(3), P(4), P(5), P(6), P(1), (P(7)) list 0
   In this case only the reference picture associated with P(1) has been reordered. In some cases, this will provide reasonable coding efficiency while reordering fewer reference pictures.

Table 2 in FIG. 2 gives another example for a 3-layer coding with Bs and B pictures (for typical Main profile applications). Similar to the example in Table 1 (which is mainly for a Baseline application), the DPB size required by this arrangement is also 6 pictures. The example in Table 1 can also be used for Main profile applications; however, the setting in Table 2 will usually give much better coding performance. A Main profile application will support I pictures, P pictures and B pictures, both B and Bs, while a Baseline application does not support any B pictures. B pictures refer to bi-directional pictures. While macroblocks within P pictures may only have a single reference, macroblocks within B or Bs pictures may have two references, typically one preceding reference and one successive reference for example. The difference between B pictures and Bs pictures, is that B pictures are transitory and may not be used as a reference, while Bs pictures are saved and available as references to other B pictures, and possibly P pictures

Table 3 in FIG. 3 gives one example for a 33-picture clip using sub-sequences arranged in 4 layers, including a third enhancement layer 18, referred to here as layer-3. The picture coding order (from 0 to 32) is given for each picture. The example shown contains only I pictures and P pictures, so it would be suitable for Baseline applications. The coding order continues to follow the basic rule described above.

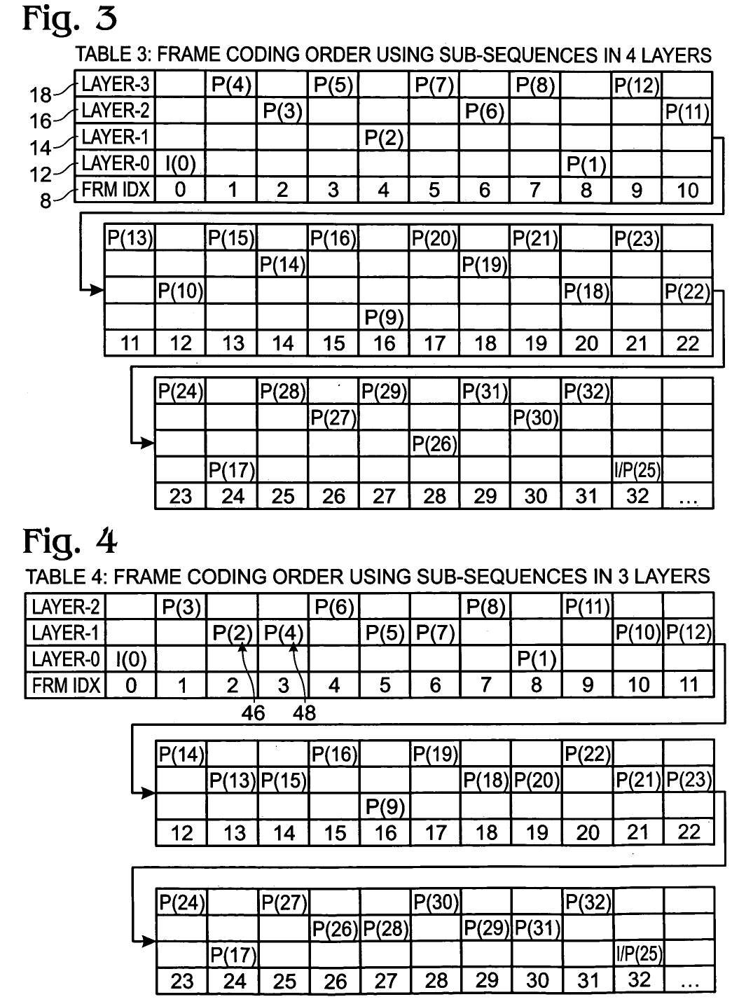

Table 4 in FIG. 4 gives another example for a 33-picture clip arranged in 3 sub-sequence layers. The picture coding order (from 0 to 32) is given for each picture. The temporal scaling factor has been modified by providing sequential pictures within the same layer, in this case layer 2, for example pictures P(2) 44 and P(4) 46 at Form Idx position 2 and 3. The coding sequence still follows the rule provided above.

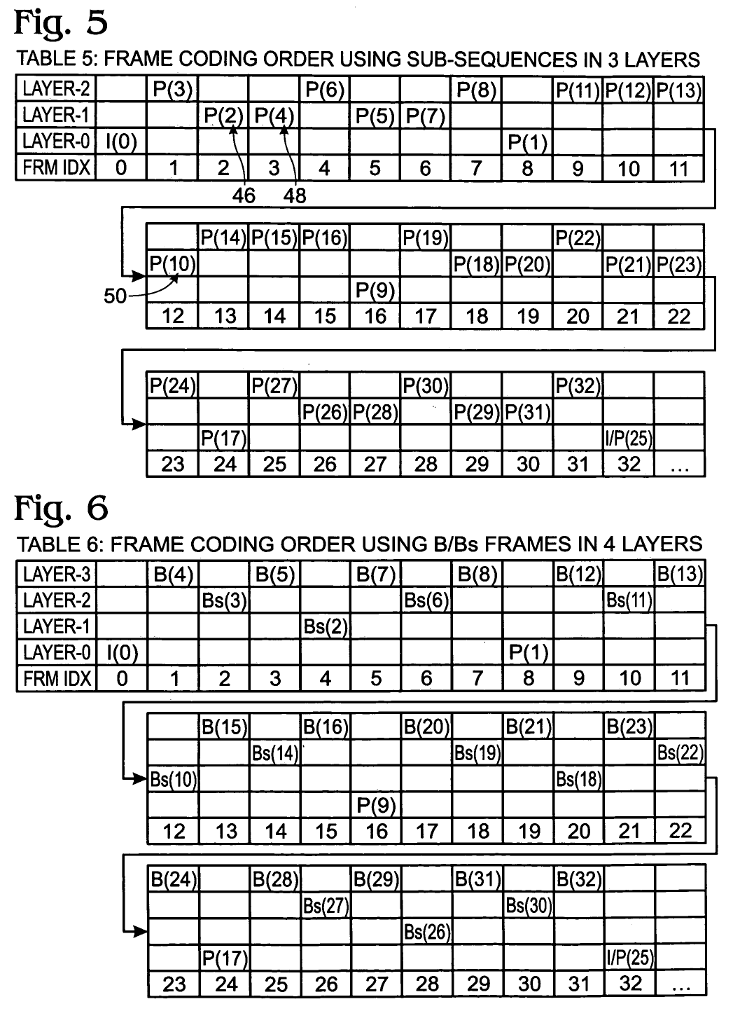

Table 5 in FIG. 5 gives another example for a 33-picture clip arranged in 3 sub-sequence layers. This sequence illustrates that the sequence does not need to be symmetrical throughout the GOP while still following the rule provided above. For example, layer-1 sometimes has a sub-sequence that is only a single picture long as shown at P(10) 50 at Form Idx position 12, while at other times the subsequence is two pictures long as shown at P(2) 46 and P(4) 48 at Form Idx position 2 and 3. Layer-2 similarly does not maintain the same scaling factor throughout.

Table 6 in FIG. 6 gives another example for a 4-layer coding with Bs and B pictures (for typical Main profile applications). The example in Table 4 can also be used for Main profile applications; however, the setting in Table 6, which is shown in FIG. 6, will usually give much better coding performance. The top most layer, in this case layer 3, may be coded as either B or Bs pictures without incurring significant performance degradation. The intermediate layers in this case layer 1, and layer 2, can be coded as either Bs or B pictures, in some applications Bs pictures may be preferred for intermediate layers to improve coding efficiency.

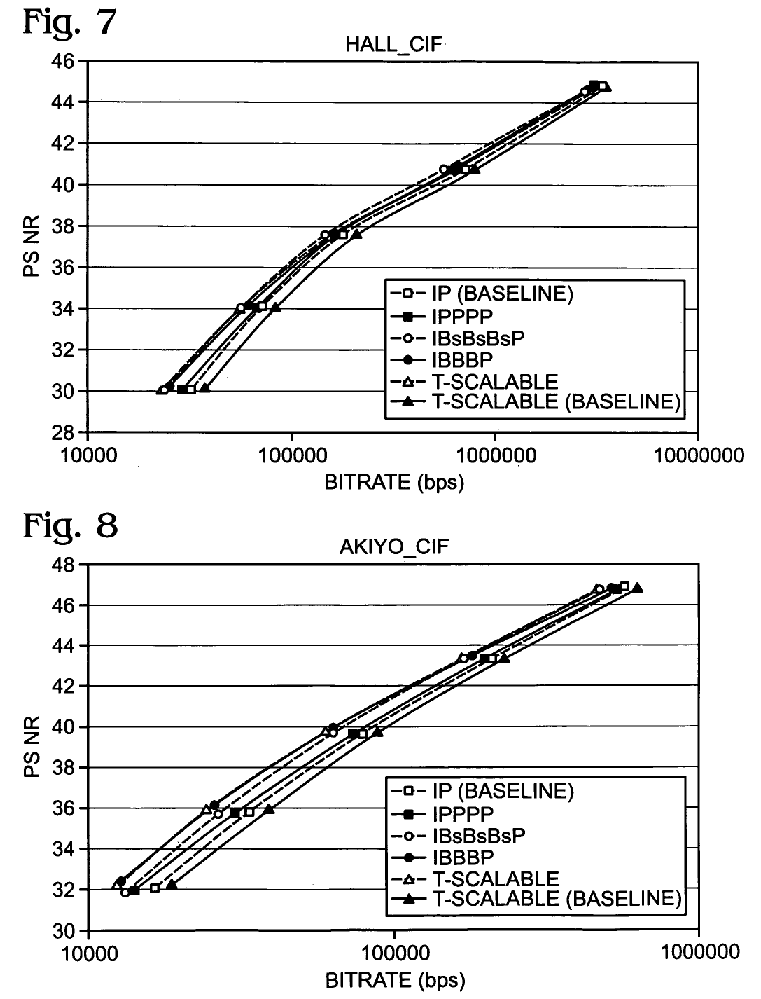

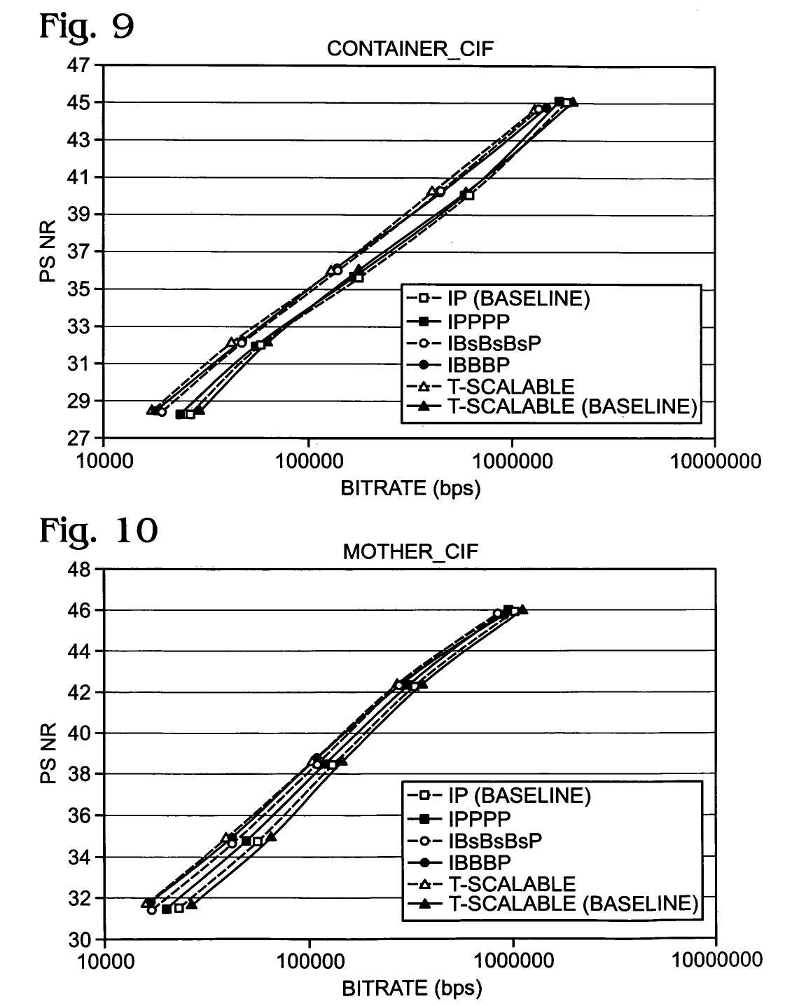

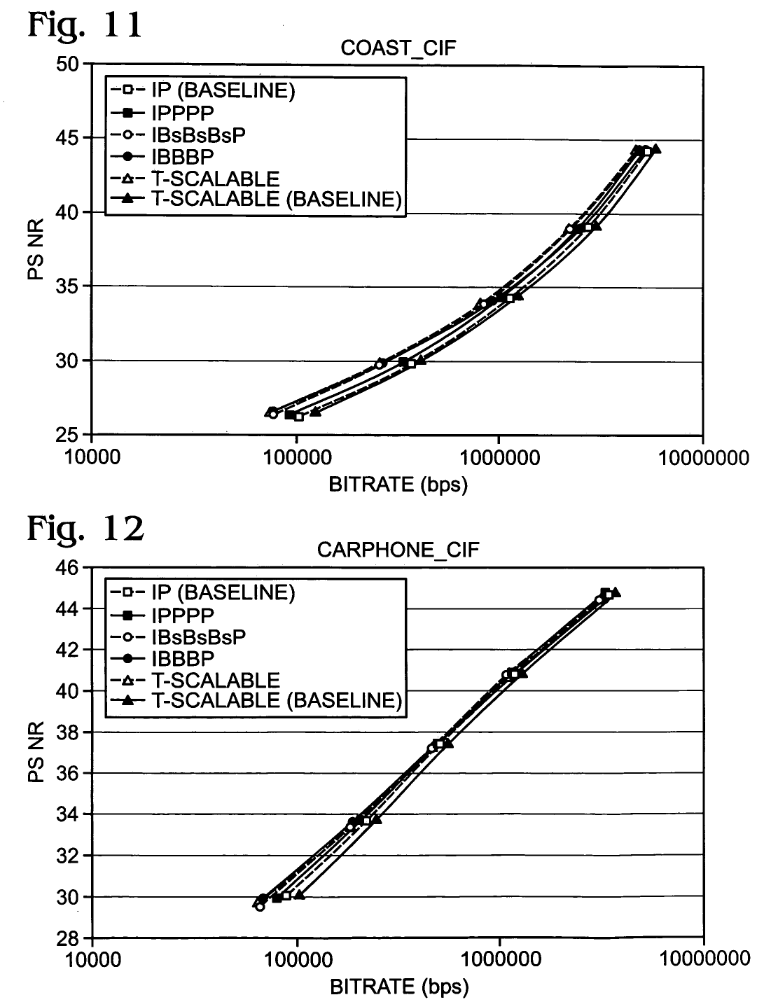

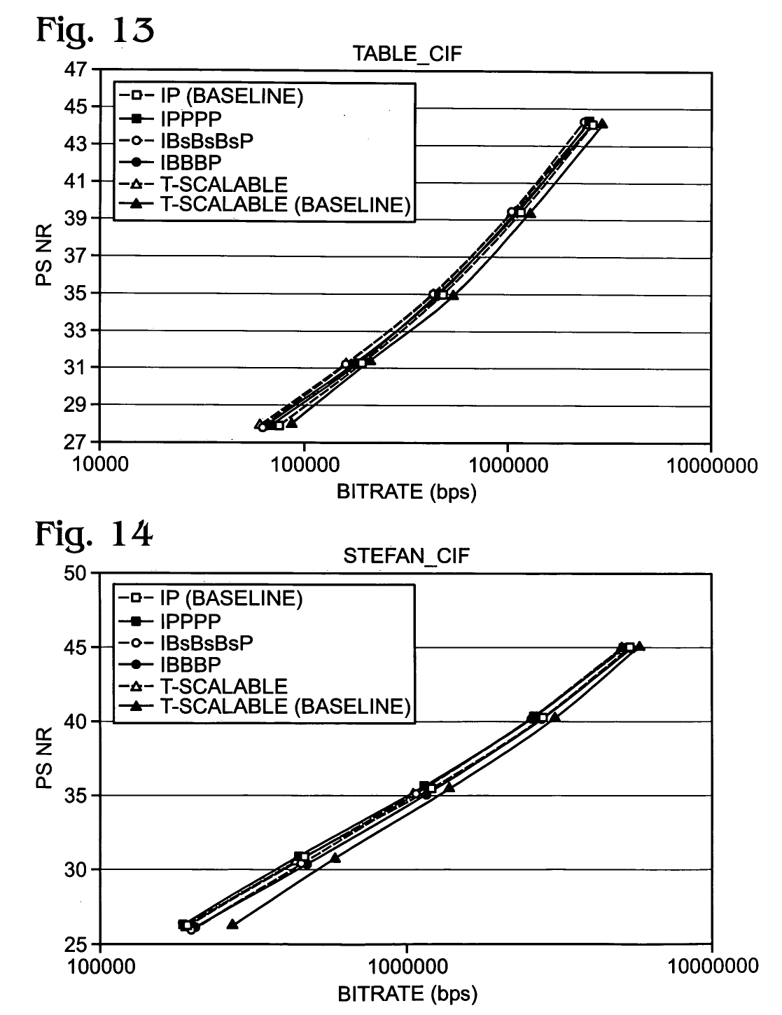

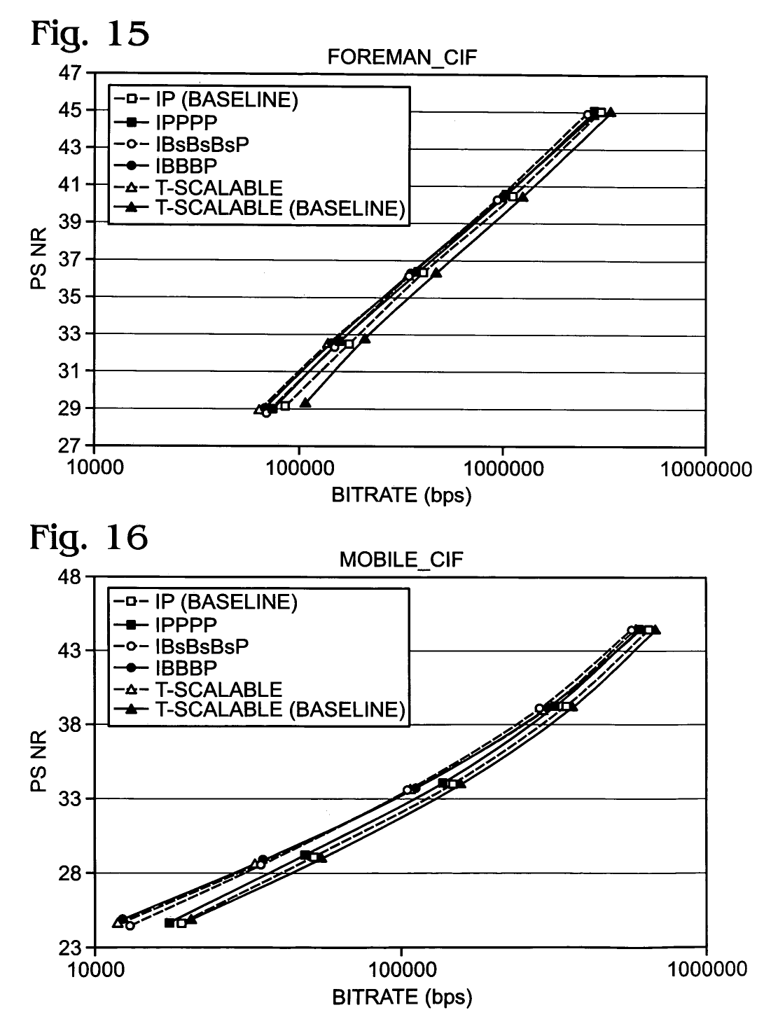

Experiments were conducted for 10 CIF format sequences based on the lasted AVC codec JM8.1a. There are in total six settings for each sequence: (a) Baseline IPPP non-scalable; (b) Main IPPP non-scalable; (c) Main IBsBsBsP non-scalable; (d) Main IBBBP naturally scalable; (e) Main IBBsBP scalable as shown in FIG. 2; and (f) Baseline IPPP scalable as shown in FIG. 1. Graphs comparing PSNR to bitrate are provided in FIGS. 7 through 16.

For each setting, 297 pictures are coded for each sequence into one GOP, i.e., only the first picture of each sequence is coded as Intra picture.

Among all the four Main-profile coding options discussed above i.e., (b), (c), (d) and (e), the scalable coding option on average gives the best coding efficiency, even though the improvement is small. The experiments showed that the temporal scalable coding option for Baseline has some overhead, roughly 0.3 dB on average, comparing to the non-scalable Baseline coding option. Given the solution is easy to implement and can be used in many low-complexity systems, the overhead should be acceptable in practice.

In operation, embodiments of the present method achieve temporal scalability by providing a coding sequence that allows an encoder to eliminate a higher order layer while maintain the coding of the lower layers. Since the lower layers do not rely on upper layers for references, they may still be coded. In this manner, the picture rate of the video sequence may be changed according to the available bandwidth, or the capabilities of a given decoder or sending system.

In some embodiments of the present method, the encoder determines which enhancement layers may be sent and eliminates the higher-level enhancement layers throughout the coding operation.

In other embodiments of the present method, the encoder may dynamically eliminate an upper enhancement layer and then resume transmission of the previously eliminated layer, or layers, at a later point based upon the availability of resources or bandwidth. In some embodiments, for example where a layer relies on previous pictures within the same layer as references, the sequence may not be able to resume the eliminated upper layer until a suitable I picture, which is wholly intra encoded without any interdependencies, is reached. This may be the case for a streaming server, for example. In other embodiments, where a layer relies solely on pictures from lower layers to provide reference pictures, the sequence may be able to resume the eliminated upper layer whenever the necessary resources or bandwidth become available.

In some embodiments, an encoder will be able to resume encoding the eliminated upper layer whenever resources or bandwidth become available, because the encoder has access to all the necessary picture information needed to provide reference pictures.

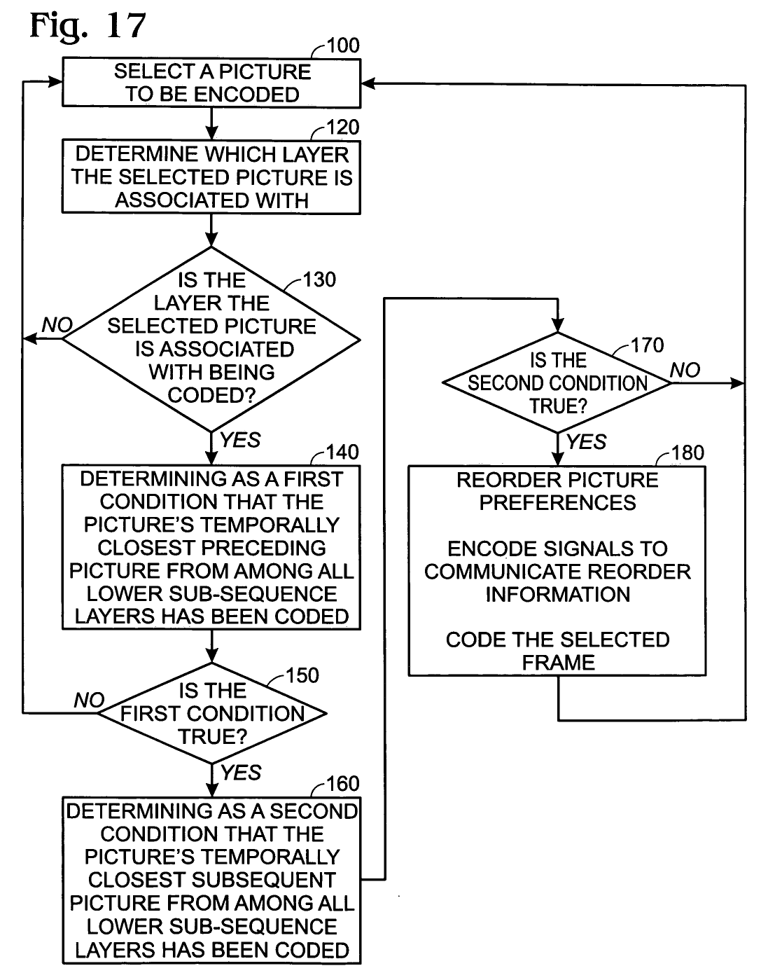

Referring now to FIG. 17, which illustrates the steps in an embodiment of a coding process implementing the present method. The encoder selects a picture to be encoded as indicated at step 100. At step 100, the encoder will start initially with the temporally earliest picture. The encoder will generally attempt to proceed sequentially. If a picture is not encoded, because it fails one of the encoding conditions discussed below, it will remain in an input buffer possibly until the buffer exceeds its capacity. The encoder may proceed sequentially until it encodes a picture that has satisfied the encoding conditions. The encoder will then select the temporally earliest uncoded pictures in the input buffer. In some embodiments of the present method, the encoder will select the temporally earliest uncoded picture following a preceding successfully encoded picture. This scheme of selecting pictures will select pictures within a given layer in sequential order.

In step 120, the encoder then determines which sub-sequence layer the selected picture is in. In an embodiment of the present method, the layer information is provided using subsequence SEI messages. This enables the encoder to make the determination of which sub-sequence layer the picture is associated with without having to actually load the actual picture.

Step 130 evaluates whether the selected picture is in a sub sequence layer that is to be encoded. If the selected picture is in a sub sequence layer that is to be encoded, the coding process continues. If not, another picture is selected by returning to step 100.

At step 140 the encoder determines whether the selected picture's temporally closest preceding picture among all lower sub-sequence layers has been coded.

Step 150 evaluates whether the condition in step 140 is true. If so, the coding process proceeds. If not, another picture is selected by returning to step 100.

At step 160 the encoder determines whether the selected picture's temporally closest subsequent picture among all lower sub-sequence layers has been coded.

Step 170 evaluates whether the condition in step 160 is true. If so, the coding process proceeds. If not, another picture is selected by returning to step 100.

At step 180, the reference pictures for the selected picture are reordered. The reordering may be accomplished using a reordering mechanism available within H.264 AVC coding. The reordering information is then encoded into a bitstream to communicate the reordering information. The selected picture is then encoded into the bitstream.

The term picture as used herein may generally refers to a picture, a frame, a field, or other suitable portion of a video sequence. Each picture one or more slices, which may further include one or more macroblocks, as is understood by one of ordinary skill in the art. Accordingly, the methods described herein may be applied to pictures, frames, fields, or other suitable portions of a video sequence.

It may be obvious to a person of ordinary skill in the art that the basic idea of the methods described may be implemented in a variety of ways. Although embodiments, including certain preferred embodiments, have been discussed above, the coverage is not limited to any specific embodiment. Rather, the claims shall determine the scope of the invention.

What is claimed is:

1. A method of coding a temporally scalable video sequence comprising:
providing a first picture associated with a base sub-sequence layer;
providing a second picture associated with a first upper sub-sequence layer above the base sub-sequence layer;
providing a third picture associated with a second upper sub-sequence layer above the first upper sub-sequence layer;
identifying a selected picture having a temporally nearest previous picture from among all lower sub-sequence layers and a temporally nearest subsequent picture from among all lower sub-sequence layers;
determining as a first condition that the temporally nearest previous picture has been coded;
determining as a second condition that the temporally nearest subsequent picture has been coded;
coding the selected picture when both the first condition is true and the second condition is true.

2. The method of claim 1, wherein the first picture is an I picture, a P picture, a B picture, or a Bs picture.

3. The method of claim 2, wherein the second picture is an I picture, a P picture, a B picture, or a Bs picture.

4. The method of claim 3, wherein the third picture is an I picture, a P picture, a B picture, or a Bs picture.

5. The method of claim 4, wherein the selected picture is a P picture, a B picture, or a Bs picture.

6. The method of claim 1, wherein identifying a selected picture comprises sequentially identifying pictures in temporal order from among uncoded pictures.

7. The method of claim 6, wherein identifying a selected picture comprises identifying the temporally earliest uncoded picture located temporally between two successfully coded pictures.

8. The method of claim 1, further comprising determining which upper layer the selected picture is associated with and coding the selected picture only when the selected picture is associated with an upper layer that is set to be encoded.

9. The method of claim 1, further comprising reordering picture references associated with the selected picture.

10. The method of claim 9, wherein reordering picture references comprises reordering the picture references according to each reference pictures temporal distance from the selected picture.

11. The method of claim 10, wherein reference pictures having the same temporal distance are reordered so that a reference picture preceding the selected picture is positioned before a reference picture following the selected picture.

12. The method of claim 10, wherein reference pictures having the same temporal distance are reordered so that a reference picture following the selected picture is positioned before a reference picture preceding the selected picture.

13. The method of claim 10, wherein reordering picture references is accomplished by providing a reorder command for each reference picture to be pulled forward.

14. The method of claim 10, wherein reordering picture references reorders a portion of the picture references.

15. The method of claim 14, wherein picture references within one temporal distance of the selected picture are reordered.

16. A method of coding a temporally scalable video sequence comprising:
coding a first picture within a video sub-sequence base layer;
coding a second picture within a video sub-sequence base layer after coding the first picture;
coding a third picture within a first upper video sub-sequence layer after coding the second picture; wherein the third picture is temporally interposed between the first picture and the second picture;
coding a forth picture within a second upper video sub-sequence layer that is above the first upper video sub-sequence layer after coding the third picture; wherein the forth picture is temporally interposed between the first picture and the third picture; and
reordering picture references associated with the forth picture.

17. The method of claim 16, wherein the first picture is an I picture, a P picture, or a Bs picture.

18. The method of claim 17, wherein the second picture is a P picture, or a Bs picture.

19. The method of claim 18, wherein the third picture is a P picture, or a Bs picture.

20. The method of claim 19, wherein the forth picture is a P picture, a B picture, or a Bs picture.

21. The method of claim 16, wherein the forth picture is coded only when the second upper video sub-sequence layer is set to be encoded.

22. A method of coding a temporally scalable video sequence comprising:
providing a first video sub-sequence within a base layer;
providing a second video sub-sequence within a first enhancement layer;
providing a third video sub-sequence within a second enhancement layer that is above the first enhancement layer;
sequentially selecting pictures within the third video sub-sequence, reordering picture references associated with each selected picture; and encoding each selected picture only after confirming that its nearest preceding temporal neighbor selected from both the second video sub-sequence and the first video sub-sequence has been coded and its nearest subsequent temporal neighbor selected from both the second video sub-sequence and the first video sub-sequence has been coded.

23. The method of claim 22, further comprising preventing the encoding of the third video sub-sequence within a second enhancement layer for a period of time.

24. The method of claim 23, further comprising preventing the encoding the second video sub-sequence within the first enhancement layer for a period of time.

25. The method of claim 24, further comprising resuming the encoding the second video sub-sequence within the first enhancement layer after the period of time.

26. The method of claim 25, further comprising resuming the encoding the third video sub-sequence within the second enhancement layer after the period of time.

27. A method of coding a temporally scalable video sequence comprising:
encoding an I picture within a base sub-sequence layer;
encoding a first P picture within the base sub-sequence layer after encoding the I picture, wherein the first P picture is temporally subsequent to I picture; and
encoding a second P picture within an enhancement sub-sequence layer after encoding the first P picture, wherein the second P picture is temporally interposed between the I picture and the first P picture.
